(19) United States
(12) Patent Application Publication
(10) Pub. No.: US 2013/0155823 A1
(43) Pub. Date: Jun. 20, 2013

(54) SMOOTH TIMEPIECE BEARING

(71) Applicant: ETA SA Manufacture Horlogere Suisse, Grenchen (CH)

(72) Inventors: Laurent Kaelin, Sonvilier (CH); Julien Moulin, Volleges (CH)

(73) Assignee: ETA SA Manufacture Horlogere Suisse, Grenchen (CH)

(21) Appl. No.: 13/710,831

(22) Filed: Dec. 11, 2012

(30) Foreign Application Priority Data
Dec. 16, 2011 (EP) 11194060.7

(51) Int. Cl. G04B 31/00; G04B 31/06

(52) U.S. Cl. CPC G04B 31/00; G04B 31/06
USPC 368/324; 264/242

(57) ABSTRACT

Smooth timepiece bearing (1).

It includes a core (5) of plastic material injected into a cavity of revolution (4) of an outer cage (3).

It also includes an inner cage (2) contained within said cavity (4) and said core (5) is injected between said inner cage (2) and said outer cage (3).

Said core (5) can move with an operating clearance relative to said outer cage (3) and cannot be removed from said outer cage (3) and can move with an operating clearance relative to said inner cage (2), and cannot be removed from said inner cage (2).

This application claims priority from European Patent Application No. 11194060.7 filed Dec. 16, 2011, the entire disclosure of which is incorporated herein by reference.

### FIELD OF THE INVENTION

The invention concerns a smooth timepiece bearing.

The invention also concerns a timepiece movement including at least one smooth bearing of this type.

The invention also concerns a timepiece including at least one such smooth bearing.

The invention also concerns a method of manufacturing a smooth timepiece bearing.

The invention concerns the field of horology, and more specifically the field of guide members and bearings.

### BACKGROUND OF THE INVENTION

Essentially, two types of timepiece bearings are known:
ball bearings comprising a large number of components, whose shake has to be adjusted during assembly;
smooth bearings which are expensive to make because of the desired precision, they have mediocre shock resistance when they comprise a jewel and it is also necessary to adjust their shake.

In both cases, the components associated with these bearings have to be made with a high level of precision.

Lubrication of the bearings is a difficult area which requires care and maintenance during use.

CH Patent No. 559 393 B5 in the name of PORTESCAP illustrates a shock absorber bearing for a watch, with a core which is a resilient part, with no clearance between the different concentric cages comprised in this bearing.

FR Patent Application No. 1 579 777 A in the name of FRATELLI BORLETTI discloses a timepiece balance pivot with a plastic disc used as an endstone for the rounded end of a balance. This disc is housed inside a cavity of a setting carrying an annular jewel. This endstone disc can be injection moulded.

FR Patent No. 1 587 976 in the name of KURUCZ AND MATTHEY discloses a timepiece shock absorber bearing with a solid plastic bearing housed in a central recess, in a similar manner to CH Patent No. 559 383 B5 mentioned above. When the plastic material shrinks, the material closes around a rib and assembles the body of the bearing in its support with no clearance.

US Patent Application No. 2 956 394 A in the name of DUBOIS (TISSOT) discloses a cast bearing for a watch. As in the aforementioned FR Patent Application No. 1 587 776 A, the conical corner shape fixedly secures the moulded element as it cools.

CH Patent No. 583 934 B5 in the name of PORTESCAP discloses a bearing for a timepiece wheel set pivot, similar to FR Patent Application No. 1 587 976 A above, but with a modified bottom shape.

### SUMMARY OF THE INVENTION

The invention proposes to overcome these problems of the prior art by proposing less expensive bearings, with a reduced number of components, which are insensitive to shocks and do not require any particular adjustment during assembly.

The invention therefore concerns a smooth timepiece bearing, characterized in that it includes a core of plastic material injected into a cavity of revolution comprised in an outer cage, and in that said core can move with permanent residual operating clearance relative to said outer cage and cannot be removed from said outer cage.

According to a feature of the invention, said smooth bearing further includes at least one inner cage contained in said cavity, and said plastic core is injected between said inner cage and said outer cage and said core can move with permanent residual operating clearance relative to said inner cage and cannot be removed from said inner cage.

According to a feature of the invention, said core is delimited by an outer surface of revolution of said inner cage and by an inner surface of revolution of said outer cage.

According to a feature of the invention, said external surface of revolution and said inner surface of revolution are coaxial about the same axis of revolution.

According to a feature of the invention, said outer surface of revolution and/or said inner surface of revolution includes at least one groove or one shoulder of revolution for immobilising said core in the direction of an axis of revolution common to said outer surface of revolution and said inner surface of revolution.

According to a feature of the invention, the plastic material forming said core has a shrinkage factor of between 2.0% and 3.0% which determines the operating clearance of said smooth bearing between said inner cage and said core on the one hand, and between said outer cage and said core on the other hand.

According to a feature of the invention, said smooth bearing is formed exclusively of said inner cage, said core and said outer cage.

According to a feature of the invention, a plurality of inner cages, comprising contact surfaces of revolution coaxial to each other and to said cavity about the same axis of revolution, are positioned in said cavity, said inner cages being fitted inside each other and separated from said cavity, as regards the outermost cage, and in pairs as regards the other cages, in each case by a core of plastic material injected into a chamber delimited by the inner volume of the outermost cage, and by the outer volume of the innermost cage.

The invention also concerns a timepiece movement including at least one smooth bearing of this type.

The invention also concerns a timepiece including at least one such smooth bearing.

The invention further concerns a method of manufacturing a smooth timepiece bearing, characterized in that the following steps are performed:
an outer cage is prepared, which is intended to be incorporated in said smooth bearing and includes a cavity of revolution about an axis of revolution,
said cavity is used as an injection or casting chamber;
plastic material is injected or cast in said chamber to form a core delimited by said cavity;
the conditions for thermal or crystal shrinkage of said plastic material are ensured to limit said shrinkage to a range of between 2.0% and 3.0%;
said material is allowed to shrink completely before said smooth bearing is used;

According to a feature of the invention, before said injection or casting is performed:
an injection or casting chamber is delimited around said cavity of revolution by the addition of sealing surfaces connected to said cavity; and

said injection or casting of plastic material is carried out in said chamber to form a core delimited by said cavity and said sealing surfaces;
after said plastic material has been completely shrunk, said sealing surfaces are moved away.

According to a feature of the invention before said injection or casting is performed:
an inner cage, which is intended to be incorporated in said smooth bearing, is inserted in said cavity of revolution, coaxially to said outer cage in said axis of revolution;
said injection or casting chamber is delimited by an outer surface of revolution of said inner cage and by an inner surface of revolution of said outer cage.

According to a feature of the invention, before said injection or said casting is performed, said injection or casting chamber is delimited by an outer surface of revolution of said inner cage and by an inner surface of revolution of said outer cage, and by the addition of sealing surfaces connected to said cavity and to said inner cage respectively on the edge of said inner surface of revolution and said outer surface of revolution;
and, after said plastic material has completely shrunk, said sealing surfaces are moved away.

### BRIEF DESCRIPTION OF THE DRAWINGS

Other features and advantages of the invention will appear upon reading the following detailed description, with reference to the annexed drawings, in which:

FIG. 1 shows a schematic cross section, in a plane passing through an axis of revolution, of a smooth bearing according to the invention, in a first embodiment with a moulded plastic part in an outer cage, during the injection or casting of the plastic material forming said core.

FIG. 2 shows, in a similar manner to FIG. 1, a second embodiment of the invention, with a moulded plastic core between an inner cage and an outer cage during the injection or casting of the plastic material forming said core.

FIG. 3 shows a second embodiment of the invention, in a similar manner to FIG. 2, after the plastic material forming said plastic core has shrunk.

FIG. 4 shows, in a similar manner to FIG. 3, a variant of the second embodiment of the invention after the plastic material forming said plastic core has shrunk.

FIG. 5 shows schematically a top view and a cross-section similar to the preceding Figures, of a smooth bearing according to the invention made without a mould.

FIG. 6 shows schematically a top view and two cross-sections similar to FIGS. 1 to 4 of a smooth bearing according to the invention made with a mould comprising injection or casting channels visible in the top view and in one of the two cross-sections.

FIG. 7 shows block diagrams of a timepiece comprising a movement which includes a smooth bearing according to the invention;

FIG. 8 illustrates an example of this type of bearing, including an outer cage, separated from an intermediate inner cage by a first core, and an intermediate cage separated from an axial inner cage by a second core;

FIG. 9 shows examples of operating clearance JP, axial clearances JA1, JA2, and radial clearances JR1, JR2, in such a bearing.

### DETAILED DESCRIPTION OF PREFERRED EMBODIMENTS

The invention concerns the field of horology, and more specifically the field of guide members and bearings.

The invention more particularly concerns a smooth bearing 1.

According to the invention, this smooth bearing 1 includes a core 5 made of plastic material injected into a cavity of revolution 4 comprised in an outer cage 3. This core 5 can move with a permanent residual operating clearance relative to outer frame 3, and cannot be removed from said outer cage 3.

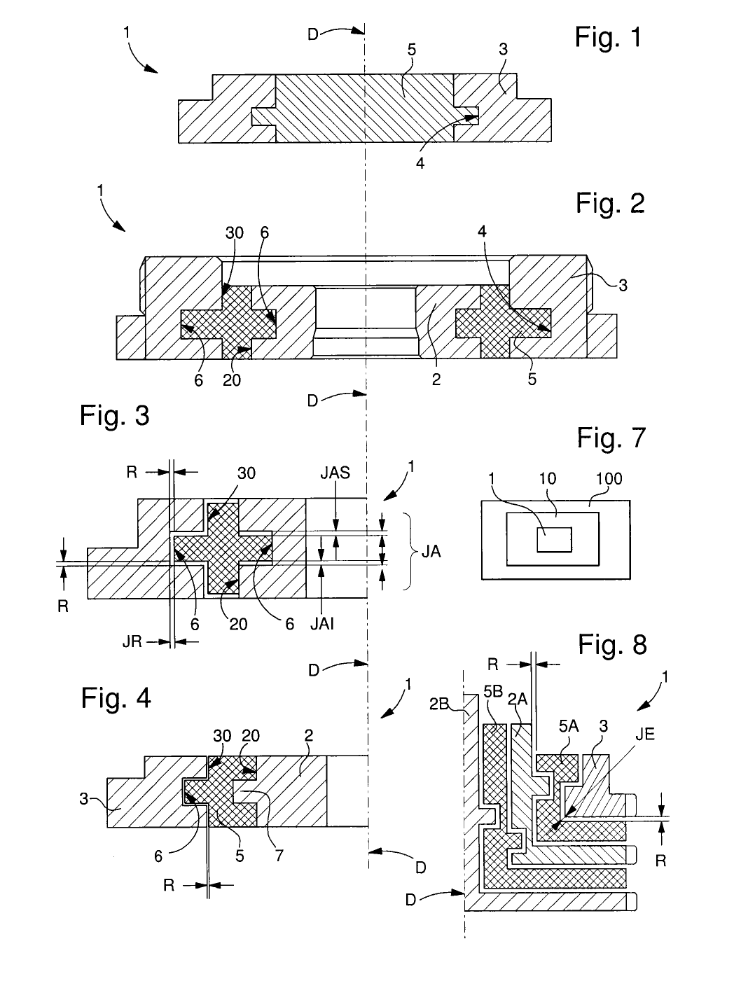

This first embodiment is shown in FIG. 1. After complete polymerisation, the plastic material shrinks slightly, which is sufficient to ensure the operating clearance of the bearing JP, necessary for the smooth bearing to work properly. Since core 5 has homothetic geometry to that of cavity 4, and as the shrinkage of plastic material is regular, the geometry of core 5 is as good as that of cavity 4. For optimum operation therefore, it should be ensured that cavity 4 has very good circularity. Respecting dimensions is unimportant however since adjustment occurs via the injection or casting method, preferably by injection.

This shrinkage may also be used to obtain a radial play JR and/or end play JA, the value of which is thus controlled.

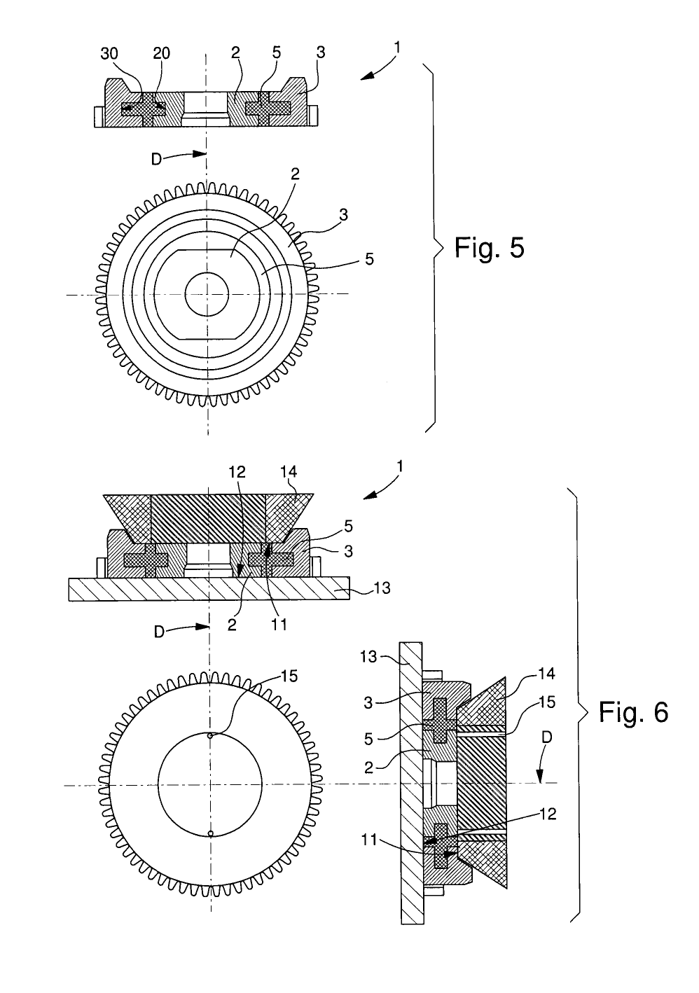

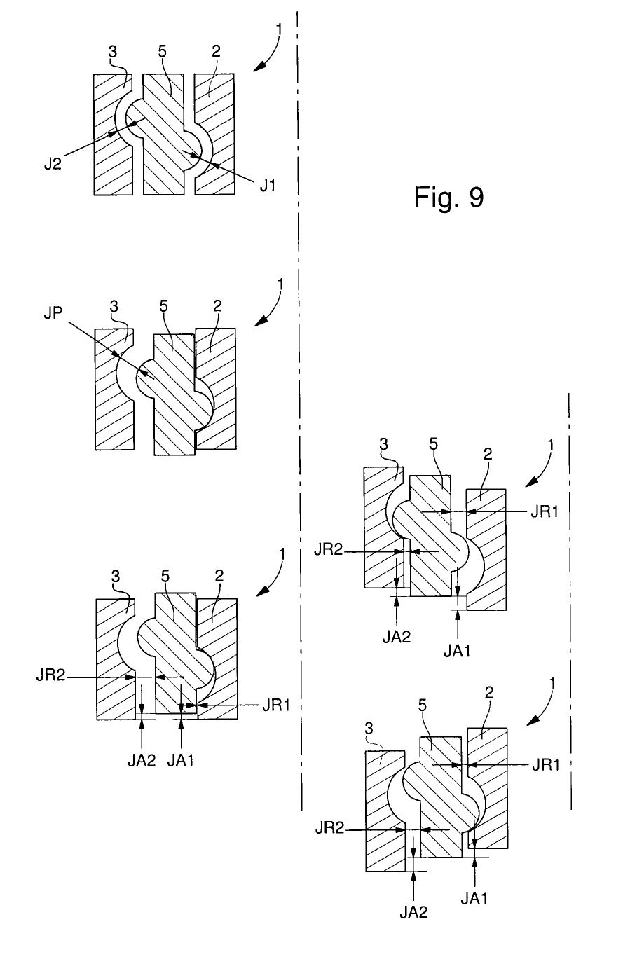

According to a preferred implementation shown in FIGS. 2 to 6, in a second embodiment, smooth bearing 1 also includes an inner cage 2 contained within cavity 4. The plastic core 5 is therefore injected between inner cage 2 and outer cage 3. The core can thus move with a permanent residual operating clearance relative to inner cage 2 and cannot be removed from said inner cage 2.

Preferably, core 5 is delimited by an outer surface of revolution 20 of inner cage 2 and by an inner surface of revolution 30 of outer cage 3.

Preferably, this outer surface of revolution 20 and inner surface of revolution 30 are coaxial about the same axis of revolution D.

Thus, in a preferred embodiment, the core 5 is entirely a surface of revolution, as regards the contact surfaces thereof with outer cage 3 and with inner cage 2 when said inner cage exists.

Preferably and particularly advantageously, the outer surface of revolution 20 and/or said inner surface of revolution 30 includes at least one groove 6 or shoulder 7 of revolution for immobilising core 5 in the direction of an axis of revolution D common to outer surface of revolution 20 and inner surface of revolution 30.

If possible, both the outer surface of revolution 20 and inner surface of revolution 30 include at least one such groove 6 or shoulder 7 of revolution for immobilising core 5 in the direction of axis of revolution D, as seen in the Figures.

In a particular embodiment seen in FIG. 4, one of outer surface of revolution 20 and inner surface of revolution 30 includes at least one groove and the other at least one shoulder, or vice versa. Said at least one groove and said at least one shoulder are of revolution and are for immobilising core 5 in the direction of axis of revolution D.

The choice of plastic material is important. Preferably, the plastic material forming core 5 has a shrinkage coefficient of between 2.0% and 3.0% which determines the first operating clearance J1 of smooth bearing 1 between inner cage 2 and core 5 on the one hand, and the second operating clearance J2 between outer cage 3 and core 5 on the other hand. The operating clearance of the bearing JP is therefore equal to the sum of first operating clearance J1 and second operating clearance J2.

For the implementation in FIG. 3, where shrinkages R are axially and radially equivalent, the resulting end play JA is approximately twice the radial play JR.

Depending on the material used, this thermal or crystal shrinkage also conditions the bearing clearance.

FIGS. 3 and 4 illustrate shrinkage R after complete polymerisation of the plastic material. The end play and radial play of bearing 1 is defined by the shrinkage rate and by the geometry of the bearing. For example, in the case of FIG. 3, a 2.5% shrinkage of 0.4 mm walls corresponds to a shake of 0.010 mm which is perfectly suitable for normal horological applications. This shake arises from the process itself and is thus guaranteed from one part to another.

Each operating clearance, first operating clearance J1 between inner cage 2 and core 5 on the one hand, and second operating clearance J2 between outer cage 3 and core 5 on the other hand if there is one, is comprised between 0.004 mm and 0.012 mm.

Preferably, each radial operating clearance, first radial operating clearance JR1 between inner cage 2 and core 5 on the one hand and second radial operating clearance JR2 between outer cage 3 and core 5 on the other hand if there is one, is comprised between 0.004 mm and 0.012 mm.

Preferably, each operating clearance J1, J2 is comprised between 0.006 mm and 0.010 mm.

Preferably, each radial operating clearance JR1, JR2 is comprised between 0.006 mm and 0.010 mm.

In a preferred embodiment, the smooth bearing 1 according to the invention is exclusively formed of inner cage 2, core 5 and outer cage 3.

The invention also concerns a timepiece movement 10 including at least one such smooth bearing 1.

The invention also concerns a timepiece movement 100 including at least one smooth bearing 1 and/or one movement 10 of this type.

The invention further concerns a method of manufacturing a smooth timepiece bearing 1 characterized in that the following steps are performed:
an outer cage 3, which is intended to be incorporated in smooth bearing 1 and which comprises a cavity 4 of revolution about an axis of revolution D, is prepared;
cavity 4 is used as an injection or casting chamber 40;
plastic material is injected or cast in chamber 40 to form a core 5 delimited by said cavity 4;
the conditions for thermal or crystal shrinkage of said plastic material are ensured to limit the shrinkage to a range of between 2.0% and 3.0%;
the plastic material is allowed to shrink completely before smooth bearing 1 is used;

According to a particular implementation, before the injection or casting, an injection or casting chamber 40 is delimited around cavity of revolution 4, by adding sealing surfaces 11, 12, connected to cavity 4, thereby forming a mould, as seen in FIG. 6. The plastic material is then injected or cast in chamber 40 to form a core 5 delimited by cavity 4 and said sealing surfaces 11, 12. Once the plastic material has completely shrunk, these sealing surfaces are moved away.

According to a particular implementation, to obtain a smooth bearing 1 with three components, prior to performing the injection or casting, an inner cage 2, which is s intended to be incorporated in smooth bearing 1, is inserted into cavity of revolution 4, coaxially to outer cage 3 along axis of revolution D. Injection or casting chamber 40 is delimited by an outer surface of revolution 20 of inner cage 2 and by an inner surface of revolution 30 of outer cage 3.

In a particular manner, prior to performing the injection or casting, injection or casting chamber 40 is delimited by an outer surface of revolution 20 of inner cage 2, and by an inner surface of revolution 30 of outer cage 3 by adding sealing surfaces connected to cavity 4 and to inner cage 2 on the edge respectively of the inner surface of revolution 30 and outer surface of revolution 20. Once the plastic material has completely shrunk, the sealing surfaces are moved away.

Naturally, although the invention is described here in the preferred application, since it is the most economical, with a single core, it is clear that it may very easily be extended to a nesting type of manufacture with wheel sets pivoting inside each other, for example minute and hour cannon-pinions and a guide path receiving said cannon-pinions. The application to a single bearing is therefore not limiting at all, and the invention must be understood as being applicable to any type of axial pivoting guide system. Limiting the axial travel by using grooves or shoulders is very useful in the manufacture of complex wheel sets that cannot be dismantled.

Thus, the invention also concerns any type of smooth bearing 1 comprising an outer cage 3 with a cavity 4 of revolution about an axis of revolution D, wherein a plurality of inner cages 2 including contact surfaces of revolution about axis of revolution D are positioned in said cavity 4. These contact surfaces of revolution are coaxial to each other and to cavity 4, and inner cages 2 are fitted inside each other. The inner cages 2 are separated, from cavity 4 for the outermost cage, and in pairs for the other cages, in each case by a core 5 of plastic material injected into a chamber delimited by the inner volume of the outermost cage and by the outer volume of the innermost cage. Preferably, the chambers, into which the plastic material is injected to form the cores, are also delimited by sealing surfaces, for example substantially perpendicular to axis D.

FIG. 8 illustrates an example of this type of bearing 1, including an outer cage 3, separated from an intermediate inner cage 2A by a first core 5A. Intermediate cage 2A is separated from an axial inner cage 2B by a second core 5B. Each time, the shrinkage R of core 5A, 5B ensures the elementary operating clearance JE between the cages separated by the core concerned.

Owing to the invention, numerous features are improved compared to prior art bearings.

No assembly by driving in, welding, screws, rivets or similar is necessary.

In the preferred variant where one of the inner or outer cages includes either a groove or a shoulder, the smooth bearing can be handled in one piece without losing any components.

The bearing has no shock resistance problems because the core is made of plastic material.

Adjustment of the clearance is intrinsic, since it arises from the shrinkage of the plastic material during its final polymerisation.

Problems of tight adjustment tolerances dependent on narrow manufacturing tolerances are avoided and it is therefore possible to substantially decrease the operating clearance. Indeed, no particular precision is required, in diameter or in the axial direction, for the outer cage, and, where appropriate the inner cage, since the plastic material occupies all of the available volume when it is injected or cast. The injection or casting therefore compensates for all tolerances, and the shakes remain perfectly correct.

The decrease in the number of components reduces costs.

The quality risk is also reduced, since the tedious adjustment of the shake is avoided.

The division, i.e. the height of the outer cage relative to the inner cage is perfectly controlled and centred. Control and centring are provided by the plastic shrinkage symmetry and, in the case of an embodiment with a mould and sealing surfaces, by the bearing surface in the mould for aligning the two cages.

It is possible to prevent any out-of-roundness of the core, and thus any misalignment, by using several injection or casting channels, as seen in FIG. 6.

The preferred embodiment via injection ensures good control of the method and is perfectly reproducible. Injection creates the core, adjusts the shake during shrinkage, and assembles the bearing, which cannot be removed after injection, when one of the inner or outer cages has a groove or shoulder limiting movement in the axial direction.

Various plastic materials have tribological qualities that are well suited to this application. More specifically, the use of POM is satisfactory. The plastic material used may be a composite material, and integrate components that improve sliding, such as lubricant bubbles, PTFE, “Delrin®”, “Rilsan®”, “Nylon®” or suchlike. Preferably, the plastic material is chosen with a friction coefficient of between 0.07 and 0.15. The use of materials with a lower friction coefficient is possible, despite their higher cost.

Since the shrinkage occurs symmetrically, the invention controls the correct division of the gearing between a bearing wheel thereby formed and the wheel set which meshes therewith.

If the plastic material used for the core is suitably chosen, it is possible to avoid lubricating the bearing.

What is claimed is:

1. A smooth timepiece bearing, characterised in that it includes a core made of plastic material injected into a cavity of revolution comprised in an outer cage, and in that said core can move with a permanent, residual operating clearance relative to said outer cage, and cannot be removed from said outer cage.

2. The smooth bearing according to claim 1, wherein it further includes at least one inner cage contained within said cavity, and in that said plastic core is injected between said inner cage and said outer cage and in that said core can move with permanent residual operating clearance relative to said inner cage and cannot be removed from said inner cage.

3. The smooth bearing according to claim 2, wherein said core is delimited by an outer surface of revolution of said inner cage and by an inner surface of revolution of said outer cage.

4. The smooth bearing according to claim 3, wherein said external surface of revolution and said inner surface of revolution are coaxial about the same axis of revolution.

5. The smooth bearing according to claim 1, wherein said core is a surface of revolution.

6. The smooth bearing according to claim 3, wherein said outer surface of revolution and/or said inner surface of revolution includes at least one groove or shoulder of revolution for immobilising said core in the direction of an axis of revolution common to said outer surface of revolution and said inner surface of revolution.

7. The smooth bearing according to claim 6, wherein said outer surface of revolution and said inner surface of revolution each includes at least one groove or shoulder of revolution for immobilising said core in the direction of said axis of revolution.

8. The smooth bearing according to claim 6, wherein one of said outer surface of revolution and said inner surface of revolution includes at least one groove and the other at least one shoulder, or vice versa, said at least one groove and said at least one shoulder being of revolution for immobilising said core in the direction of said axis of revolution.

9. The smooth bearing according to claim 1, wherein the shrinkage coefficient of the plastic material forming said core is comprised between 2.0% and 3.0% which determines the operating clearance of said smooth bearing between said outer cage and said core.

10. The smooth bearing according to claim 2, wherein the shrinkage coefficient of the plastic material forming said core is comprised between 2.0% and 3.0% which determines the operating clearance of said smooth bearing between said inner cage and said core.

11. The smooth bearing according to claim 1, wherein each operating clearance, between said core and an inner cage surrounded by said core, or between said core and an outer cage which surrounds said core, is comprised between 0.004 mm and 0.012 mm.

12. The smooth bearing according to claim 11, wherein each radial operating clearance, between said core and an inner cage surrounded by said core, or between said core and an outer cage which surrounds said core, is comprised between 0.004 mm and 0.012 mm.

13. The smooth bearing according to claim 2, wherein it is exclusively formed of said inner cage, said core and said outer cage.

14. The smooth bearing according to claim 2, wherein a plurality of inner cages, comprising contact surfaces of revolution coaxial to each other and to said cavity about the same axis of revolution, are positioned in said cavity, said inner cages being fitted inside each other and separated from said cavity, as regards the outermost cage, and in pairs as regards the other cages, in each case by a core of plastic material injected into a chamber delimited by the inner volume of the outermost cage, and by the outer volume of the innermost cage.

15. The timepiece movement including at least one smooth bearing according to claim 1.

16. The timepiece including at least one smooth bearing according to claim 1.

17. The method of manufacturing a smooth timepiece bearing, wherein the following steps are performed:
an outer cage, which is intended to be incorporated in said smooth bearing and which comprises a cavity of revolution about an axis of revolution, is prepared;
said cavity is used as an injection or casting chamber;
plastic material is injected or cast in said chamber to form a core delimited by said cavity;
the conditions for thermal or crystal shrinkage of said plastic material are ensured to limit said shrinkage to a range of between 2.0% and 3.0%;
said plastic material is allowed to shrink completely before said smooth bearing is used;

18. The method of manufacturing a smooth bearing according to claim 17, wherein, before performing said injection or said casting:
an injection or casting chamber is delimited around said cavity of revolution by the addition of sealing surfaces connected to said cavity; and in that:
said injection or casting of plastic material is carried out in said chamber to form a core delimited by said cavity and said sealing surfaces;
after said plastic material has been completely shrunk, said sealing surfaces are moved away.

19. The method of manufacturing a smooth bearing according to claim 17, wherein, in before performing said injection or said casting:
an inner cage, which is intended to be incorporated in said smooth bearing, is inserted in said cavity of revolution, coaxially to said outer cage in said axis of revolution;
said injection or casting chamber is delimited by an outer surface of revolution of said inner cage and by an inner surface of revolution of said outer cage.

20. The method of manufacturing a smooth bearing according to claim 19, wherein, prior to performing said injection or said casting, said injection or casting chamber is delimited by an outer surface of revolution of said inner cage, and by an inner surface of revolution of said outer cage by the addition of sealing surfaces connected to said cavity and to said inner cage on the edge respectively of said inner surface of revolution and said outer surface of revolution and in that, after said plastic material has completely shrunk, said sealing surfaces are moved away.
